(19) United States
(12) Patent Application Publication
(10) Pub. No.: US 2016/0213048 A1
(43) Pub. Date: Jul. 28, 2016

(54) FRUIT JUICE PROCESSING

(71) Applicants: Innovative Strategic Design LLC, Cincinnati, OH (US); Innovative Product Management, LLC, Columbus, OH (US)

(72) Inventors: Daniel J. BLASE, St. Louis, MO (US); Cheriyan B. THOMAS, Ellington, CT (US)

(21) Appl. No.: 15/090,093

(22) Filed: Apr. 4, 2016

Related U.S. Application Data
(63) Continuation-in-part of application No. 13/047,158, filed on Mar. 14, 2011.
Application No. 13/047,158 is a continuation-in-part of application No. 11/881,364, filed on Jul. 26, 2007, now abandoned.

(51) Int. Cl. A23L 2/72; A23L 2/78; A23L 2/02

(52) U.S. Cl. CPC A23L 2/72; A23L 2/02; A23L 2/78

(57) ABSTRACT

A method of producing a reduced-calorie fruit juice beverage may include passing a fruit juice stream including non-sugar fruit juice components (fruit juice components product) and sugars through a bed of resin. Due to the resin's specific affinity for the sugar, the fruit juice is chromatographically separated into concentrated bands of the fruit juice components product and sugars that move through the bed of resin at different speeds. The concentrated band of the sugar may be withdrawn as a sugar stream from a first extraction point in the bed of resin, while the concentrated band of the fruit juice components may be withdrawn as a fruit juice components product stream from a different, second extraction point in the bed of resin. The sugar stream includes a higher concentration of the fructose, glucose, and sucrose than the feed stream, while the fruit juice components product stream includes a higher concentration of endogenous fruit juice compounds than the feed stream or the sugar stream.

### CROSS-REFERENCE TO RELATED APPLICATIONS

This application is a continuation-in-part under 35 U.S.C. §120 of U.S. application Ser. No. 13/047,158, filed on Mar. 14, 2011, which is a continuation-in-part under 35 U.S.C. §120 of U.S. application Ser. No. 11/881,364, filed on Jul. 26, 2007, which claims priority under 35 U.S.C. §365 to International Application No. PCT/US2006/003149, filed on Jan. 27, 2006, which claims priority under 35 U.S.C. §119 to U.S. Provisional Application No. 60/648,183, filed on Jan. 28, 2005, the entire contents of each of which are hereby incorporated herein by reference.

### BACKGROUND

1. Field

The present disclosure relates to a method of selectively removing sugars (mixed sugars) from a fruit juice stream to produce a low calorie fruit juice beverage that is nutritionally similar to native juice.

2. Description of Related Art

A juice is a natural fluid that is directly extracted or expressed from a plant, such as a fruit. A product (e.g., drink) consisting of directly extracted or expressed juice is considered to be 100 percent juice and can be declared as “100 percent juice. “On the other hand, a “juice beverage” is defined as a drinkable juice product that contains a juice, but contains less than 100% juice but more than 1% juice.

The U.S. Food and Drug Administration (FDA) calculates the juice percentage when using a concentrate as the minimum Brix levels listed below for single strength (100 percent) juice.

| | |
|---|---|
| Apple Juice | 11.5 brix |
| Grape Juice | 16.0 brix |
| Orange Juice | 11.8 brix |
| Pineapple Juice | 12.8 brix |

According to the FDA, “if its nutrient profile has been diminished to a level below the normal nutrient range for the juice,” then that juice to which such a major modification has been made shall not be included in the total percentage juice declaration” (21 C.F.R. §§101.30 &102.33).

Juices are an excellent source of vitamins, minerals, and other beneficial compounds. However, an 8-ounce (240 ml) glass of orange juice, for example, contains 110 calories, which is primarily from the 22 grams of sugar. A glass of orange juice has about the same sugar content and calories as a can of soda. Obesity and diabetes in the United States are moving consumers towards lower sugar, lower calorie beverages. Although juice products have a high nutritional content, there has been a decline in juice consumption due in part, to its relatively high calorie and sugar content. Currently available low calorie juice beverages are primarily diluted juices (juice beverages) with juice flavoring and do not contain the full nutritional benefits of natural whole juice.

Orange juice, as with most fruit juices, is defined and regulated by its standard of identity. This is based on the brix (soluble solids; including fructose, sucrose, and glucose) of the juice. “Brix” is a refractive index scale for measuring the amount of sugar in a solution at a given temperature. Orange juice is conventionally produced by squeezing the liquid contents from fresh oranges. The resulting juice from the squeezing is then typically passed through a centrifuge or subjected to other processes to remove small pieces of orange peel and excess pulp.

Orange juice concentrate is produced by passing finished juice through a heat exchanger to remove most (about 75% to about 90%) of the native water. The orange juice concentrate is stored in frozen form until needed. Frozen concentrate is shipped domestically and internationally to local and regional beverage plants where it is reconstituted (water is returned to the concentrate) to produce “Orange Juice” (100% Orange Juice; based on standard of identity) and “Orange Juice Beverages” (less than 100% Orange Juice; based on standard of identity). This process of juice concentration has a high-energy requirement and, therefore, can be expensive. Frozen concentrate storage and shipment can also be expensive due to its bulk.

Orange juice is also sold as a single strength product and is labeled for the retail market as “Orange Juice not from Concentrate.” This product is typically sold at a premium due to the higher quality, additional storage, and transportation cost (single strength versus concentrate), and special (more expensive) storage requirements.

U.S. Pat. No. 5,403,604 (Black) discloses passing fruit juices through two membrane filtration systems. The separation process is based on molecular size and is not a process that selectively removes sugar. The first stage involved passing fruit juice through an ultrafiltration membrane. The retentate contained water, cloud oil, oil soluble flavors, oil soluble colors, and pulp. The permeate contained water, minerals, sugar, and other lower molecular weight beneficial compounds. The permeate was subsequently passed through a nanofiltration membrane. The retentate contained water, sugar, and other middle molecular weight beneficial compounds, while the permeate contained water, minerals, and other low molecular weight compounds. The two membrane filtrations processes resulted in fractionating the juice into three molecular weight (high, medium, and low) fractions. The retentate from the first filtration (high molecular weight fraction) was then combined with the permeate from the second filtration (low molecular weight fraction) to produce a low B/A (brix acid ratio) ratio fruit juice. However, the low B/A product is missing the medium molecular weight fraction. As a result according to the FDA, “if its nutrient profile has been diminished to a level below the normal nutrient range for the juice,” then that juice to which such a major modification has been made shall not be included in the total percentage juice declaration” and would not meet the legal definition (standard of identity) of a fruit juice or a fruit juice beverage.

U.S. Pat. No. 6,299,694 (Ma) discloses separating a fructose and glucose aqueous solution into a fructose peak and a glucose peak. The solution contained purified and ion free water and two monosaccharides (carbohydrates) that have the same molecular formula (C₆H₁₂O₆, MW 180.15), but glucose has a six member ring and fructose has a five member ring structure. The solution was passed through a column of exchange resin to separate the sample into two individual sugar peaks. The calcium on the calcium resin complex is attracted to the hydroxyl group (—OH) on the sugar molecule. The fructose and glucose molecule in distilled water have different binding constants with the calcium-resin complex. The difference of the binding constants was used to separate fructose and glucose. The peaks composed of an aqueous ion-free glucose peak and an aqueous ion-free fructose peak. Ma teaches that the limitation of the resin is that the aqueous solution including the sugars and water need to be pure (contaminate free) and “free of ionic substances that would hinder the sorption capacity” of the resin in order to chromatographically separate the two sugars. Ma separates fructose and glucose but does not mention how other sugars, sugar containing compounds, or other compounds with hydroxyl groups (—OH) would interact with the resin. Ma teaches away from the combination of adding a sample that contains ions and contaminates to the column.

Those of ordinary skill in the art readily appreciate that chromatography is a very exacting science and slight modifications in the methodology, e.g., pH, free ions, endogenous contaminates (pectin, pulp, pigments, sugars, etc.), will alter the binding constant of the fructose and glucose with the calcium-resin complex. In addition the flow rate, sample size, sample preparation, ionic strength, polarity, etc. can alter the chromatographic separation of the sample. The chromatographic separation of solution of pure water and two pure carbohydrates versus a sample containing a complex mixture of chemically different compounds is totally different. (see C. F. Poole, “The Essence of Chromatography,” Elsevier Science B.V., 2003).

Fruit juices contain significant quantities of native ions. Dionex Company shows the ion concentration for a variety of fruit juices (e.g., orange juice, peach nectar, pear nectar, mango nectar, and other fruit juices). For example, orange juice contains Sodium (3 mg/L), Potassium (1843 mg/L), Magnesium (166 mg/L), and Calcium (71 mg/L). In particular, the chemical composition of orange juice includes carbohydrates (pulp, pectin, sugars) 76%, acids 9.6%, free amino acids 5.4%, ions 3.2%, vitamins 2.5%, lipids 1.2%, flavonoids 0.8%, volatile compounds 0.38%, and other non-volatile compounds, carotenoids, and enzymes 0.013%.

Conventionally, reducing the amount of sugar in juices without also reducing the nutritional component therein has been difficult. As a result, most of the low calorie juice products on the market are diluted fruit juices (juice beverages). In this regard, a number of commercially-available orange juices are supplemented with extra minerals (i.e. calcium) to meet consumer demands.

### SUMMARY

A method of producing a reduced-calorie fruit juice beverage that has most of the nutrition of full juice includes passing a feed stream of a fruit juice through a bed of resin. The fruit juice includes non-sugar fruit juice components product (hereinafter, “juice components product” or “JCP”) and sugar. As used herein, non-sugar fruit JCP includes non-sugar endogenous compounds such as native ions, pectin, flavor compounds, aroma compounds, etc. The resin has a greater affinity for the sugar than most of the juice components product. However, the resin has a relatively weak attraction with the sugars (e.g., via a weak ligand complex). The resin may include calcium ions that form a calcium-resin complex and has an attraction with the hydroxyl (—OH) functional groups on the sugar and other molecules in the fruit juice.

The method may additionally include chromatographically separating the fruit juice into concentrated bands of the fruit juice components product and sugar that move through the bed of resin. The concentrated band of the sugar moves at a slower speed through the bed of resin than the concentrated band of the fruit juice components product due to the relatively weak attraction between the resin and the hydroxyl functional group on the sugars. As a result, the fruit juice may be separated into the concentrated bands of the fruit juice components product and sugar by the difference in the binding constants of the sugars with the resin complex.

The method may also include withdrawing the concentrated band of the sugar as a sugar stream from a first extraction point in the bed of resin. The sugar stream may include a mix of various sugars, such as a mix of fructose and glucose, a mix of fructose and sucrose, a mix of sucrose and glucose, or a mix of sucrose, glucose, and fructose (dependent on the type of fruit juice).

The method may further include withdrawing the concentrated band of the juice components product stream from a second extraction point in the bed of resin. The second extraction point may be downstream from the first extraction point. The juice components product stream includes a higher concentration of native free ions, pectin, flavor compounds, and aroma compounds than the feed stream or the sugar stream. The juice components product stream also includes a higher concentration of endogenous flavor compounds, endogenous aroma compounds, endogenous acids, endogenous minerals, and endogenous vitamins than the feed stream or the sugar stream. On the other hand, the sugar stream includes a higher concentration of the fructose, glucose, and/or sucrose than the feed stream or the fruit juice components product stream.

The fruit juice components product stream is withdrawn from the bed of resin before the sugar stream. The first extraction point may be axially positioned such that a peak of the concentrated band of sugar is withdrawn from the bed of resin with the sugar stream. Conversely, the second extraction point may be axially positioned such that a peak of the concentrated band of juice components product is withdrawn from the bed of resin with the fruit juice components product stream.

The fruit juice is not subjected to a deionization process prior to passing through the bed of resin. The fruit juice may be one or more of orange juice, cranberry juice, grape juice, apple juice, pineapple juice, tangerine juice, grapefruit juice, pomegranate juice, cherry juice, blueberry juice, or strawberry juice. When the fruit juice is orange juice, the orange juice may contain less than 15 weight % pulp (e.g., less than 5 w/w %).

The method may further include adding a chelator to the fruit juice to bind with the native free ions so as to protect against a displacement of metal ions in the resin when the feed stream passes through the bed. The chelator may be added to the fruit juice at a concentration up to 20 w/w % (e.g., less than 2 w/w %). The chelator may be in a form of an acid or a salt. For instance, the chelator may be at least one of ethylenediaminetetraacetic acid (EDTA) and ascorbic acid.

The method may further include concentrating the fruit juice components product stream. The fruit juice components product stream can be concentrated by 10% to 90% or more. This concentrate results in a significant reduction in volume compared to standard juice concentrates due to the reduction of sugars. The processing cost of concentrating juices is also reduced significantly due to the reduced concentration of sugars in the fruit juice components product stream. Fruit juice components product concentrates can result in significantly less frozen shipping and frozen storage costs compared to standard concentrates due to the lower volume. Thermal, flavor, and nutritional degradation of the juice is also reduced since the concentration process requires less heat and time.

The method may further include adding a sweetener to the juice components product stream to produce the reduced-calorie fruit juice beverage. The sweetener may be at least one of a natural high-intensity sweetener or an artificial high-intensity sweetener. The natural high-intensity sweetener may be stevia. The artificial high-intensity sweetener may be at least one of sucralose, aspartame, acesulfame potassium, alitame, cyclamates, and saccharine.

A method of producing a reduced-calorie fruit juice beverage may also include passing a fruit juice stream (containing native free ions, pulp, pectin, flavor oils, acids, minerals, a chelator, and other endogenous compounds) in contact with a bed of ionic material capable of chromatographically separating the fruit juice into a “juice components product” peak from the sugar (fructose, glucose, and sucrose or fructose and glucose) peak. The fruit juice components product peak can be used to produce a product that would meet the standard of identity for a “Fruit Juice Beverage”. The native free ions are known to interfere with the chromatographic separation of the sample. The resulting fruit juice components product stream exits the column before the mixed sugar peak. Process parameters such as the removal of pulp, removal of pectin, addition of ions (cations, anions), flow rate, sample size, column diameter, column height (bed height), and pH of the fruit juice sample were modified to test various premises and to facilitate the fractionation of the fruit juice sample into a fruit juice components product peak and a sugar peak. The addition of a chelator can be added to the sample and/or eluent. The chelator would bind the free ions and thereby protect the calcium-resin complex.

An organoleptically acceptable “Fruit Juice Beverage” can be produced from the fruit juice components product stream by adding a high intensity natural and/or artificial sweetener (e.g., sucralose, aspartame, saccharine, stevia, or the like). By adding a reduced calorie sweetener, a reduced calorie “Fruit Juice Beverage” is produced. This beverage will have most of the nutritional benefits of the original fruit without all of the calories, since a considerable amount of the sugar has been removed. It should be understood that other ingredients may also be added to the beverage (e.g., flavors, pectins, minerals, or the like) and that not all of the sugar needs to be removed from the beverage.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a schematic view of a system for chromatographically separating a feed stream (fruit juice) into a non-sugar fruit juice components product peak and a sugar peak according to example embodiments.

FIG. 2 is a graphical illustration of a chromatographic separation performed by the system of FIG. 1.

FIG. 3 is a graph of the results of a chromatographic separation of a simulated fruit juice solution of fructose and dye according to example embodiments.

FIG. 4 is a graph of the results of a chromatographic separation of apple juice according to example embodiments.

FIG. 5 is a graph of the results of a chromatographic separation of concord grape juice according to example embodiments.

FIG. 6 is a graph of the results of a chromatographic separation of orange juice according to example embodiments.

FIG. 7 is a graph of the results of a chromatographic separation of orange juice, with a chelator, according to example embodiments.

### DETAILED DESCRIPTION

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and the are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

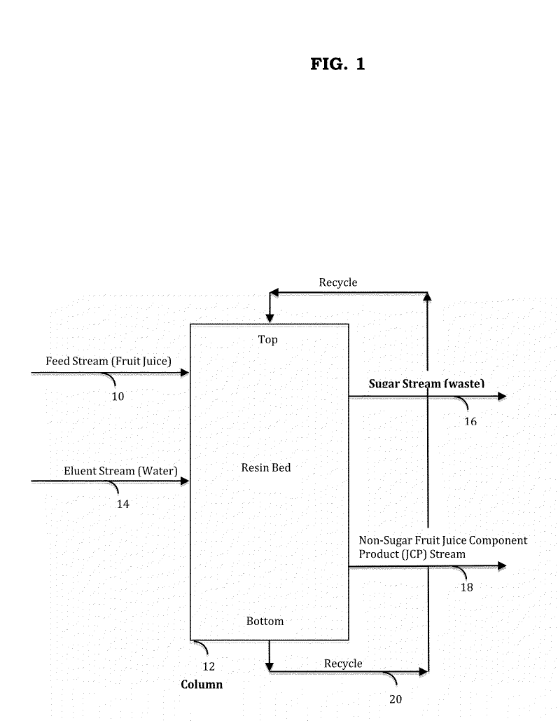

FIG. 1 is a schematic view of a system for chromatographically separating a feed stream (fruit juice) according to example embodiments. Referring to FIG. 1, a feed stream 10 of a sugar-containing liquid (e.g., fruit juice) is fed into a column 12 containing a bed of resin. The feed stream 10 may be a fruit juice stream or other suitable composition stream. In an example embodiment, the feed stream 10 is pre-treated prior to being introduced into the column 12. For instance, the feed stream 10 may be subjected to centrifugation, filtration (e.g., hollow fiber filter), and/or other operations to remove most of the pulp, to remove some of the pectin, to remove acids, to add ions (cations, anions), and/or to adjust the pH in order to facilitate the chromatographic separation of the feed stream 10. A chelator can also be added to the feed stream 10 and/or eluent stream 14. The chelator acts to bind the free ions in the feed stream 10, which protects the resin in the column 12 and improves the chromatographic separation of the feed stream 10. Suitable chelators include ethylenediaminetetraacetic acid (EDTA) and/or ascorbic acid, although example embodiments are not limited thereto. A chelator may be present at a concentration ranging up to 20 w/w %. For instance, a chelator may be present at a concentration between 0.0001 to 5 w/w % (e.g., 0.1 to 2 w/w %).

After the pretreatment, the feed stream 10 enters the top of the column 12 and passes through a bed of resin (e.g., a simulated moving bed of resin beads) to the bottom of the column 12. The flow of the feed stream 10 through the column 12 may be gravity-driven or pressure-driven. The resin is an ion exchange resin that has an attraction to sugars (e.g., fructose, glucose) in the feed stream 10. However, the resin does not actually trap and remove the sugars from the feed stream 10. Rather, the resin has an attraction for the hydroxyl (—OH) group on the sugars. As a result, the sugars will continue to move through the bed of resin with the feed stream 10 but at a slower speed than the juice components product of the feed stream 10 (e.g., in the form of concentrated bands). The difference in the binding constant with the calcium-resin complex and sugars is used to separate the individual sugars. With the proper combination of parameters for the chromatographic process, as will be discussed in further detail herein, the feed stream 10 can be separated into a juice components product stream 18 and a sugar stream 16. The sugar stream 16 is the waste stream for the chromatographic process. Suitable resin includes Dowex® Monosphere® 99CA/320 Separation Resins (by Dow Chemical Company, Midland, Mich.), although example embodiments are not limited thereto.

The sugar (waste) stream 16 is withdrawn from an upper extraction point in the column 12. The upper extraction point is below an inlet point through which the feed stream 10 is introduced. The sugar stream 16 is a mixed sugar fraction in that it includes a combination of fructose and glucose or a combination of at least fructose, glucose, and sucrose. On the other hand, the juice components product stream 18 is withdrawn from a lower extraction point in the column 12. The juice components product stream 18 has a higher concentration of ions, endogenous flavor compounds, endogenous aroma compounds, endogenous acids, endogenous minerals, endogenous vitamins, and other endogenous compounds than the sugar stream 16 (e.g., at least 45% higher, dry wt. basis). Conversely, the juice components product stream 18 has a lower sugar content than the feed stream 10, while the sugar stream 16 has a higher sugar content than the feed stream 10. In a non-limiting instance, the sugar stream 16 includes at least 45% (e.g., at least 60%) of the sugars in the feed stream 10 and no more than 35% (e.g., no more than 20%) of the non-sugar juice components in the feed stream 10. The lower extraction point for the juice components product stream 18 is below the upper extraction point for the sugar stream 16. In an example embodiment, the juice components product stream 18 has at least 45% less sugar than in the sugar stream 16. In a non-limiting instance, the non-sugar juice components product stream 18 contains at least 65% of the non-sugar juice components in the feed stream 10 and no more than 55% (e.g., no more than 35%) of the sugars in the feed stream 10.

An eluent stream 14 (e.g., water stream) may be introduced into the column 12 to assist in the separation of the feed stream 10 into the juice components product stream 18 and a sugar stream 16. Furthermore, a recycle stream 20 may be employed to improve the efficiency of the chromatographic separation. In a non-limiting embodiment, the system of FIG. 1 may be a simulated moving bed for performing the continuous process of receiving a fruit juice feed stream and fractionating it into a juice components product stream and a sugar stream. Although a single column is shown in FIG. 1, it should be understood that a plurality of columns (e.g., 2, 3, or more) may be utilized, whether arranged serially, in parallel, or a combinations thereof.

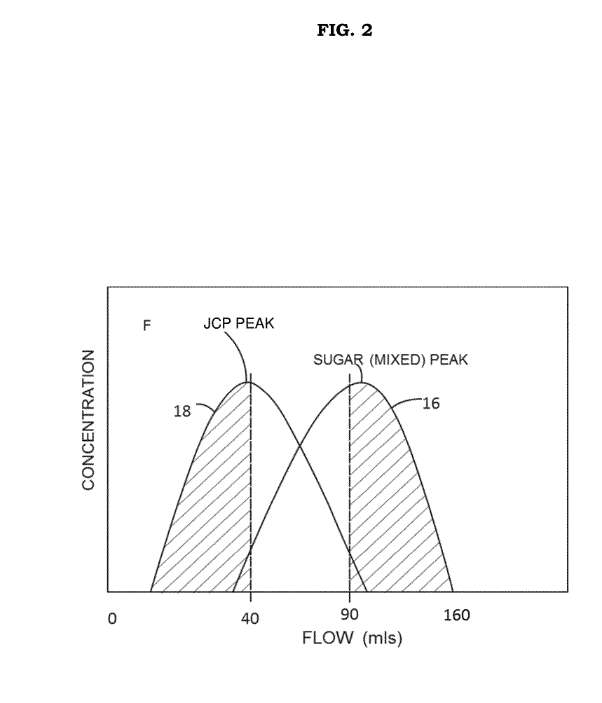

FIG. 2 is a graphical illustration of a chromatographic separation performed by the system of FIG. 1. Referring to FIG. 2, the withdrawal of the juice components product stream 18 is at a point in the column 12 where the concentration of juice components product is higher than the feed stream 10 (e.g., where the concentration of juice components product is at a maximal concentration range and the concentration of sugar is at a lower concentration range). Conversely, the withdrawal of the sugar stream 16 (e.g., sugar fraction) is at a point in the column 12 when the concentration of sugar is more than the feed stream 10 (e.g., where the concentration of sugar is at a maximal concentration range and where the concentration of juice components product is at a lower concentration range). The introduction of the feed stream 10 is located at the point in the column 12 where the least amount of separation of the sugar stream 16 and the juice components product stream 18 is occurring. The eluent stream 14 is introduced to the column 12 after the removal of the sugar stream 16 to maintain mass balance and constant flow during recycle.

The column 12 may be in a form of a plurality of columns that are run in series, parallel, cascade, or the like for additional treating time, capacity, or for special effects. In an example embodiment, when orange juice is introduced as the feed stream 10, the orange fruit juice components product fraction exiting as the juice components product stream 18 will not meet the standard of identity for “Fruit Juice” but can be used to produce a “Fruit Juice Beverage.” Notably, the juice components product stream 18 can be used for producing products that benefit both the consumer and the manufacturer.

### Chromatography

Those of ordinary skill in the art readily appreciate that chromatography is a very exacting science. The results can be very difficult/impossible to predict since slight modifications in the methodology (e.g., pH, free ions, altering the binding constant of the endogenous components with the resin) can affect the success of a separation. In addition, factors such as flow rate, sample size, sample preparation, ionic strength, polarity, etc. significantly alter the chromatographic separation of the sample and can be the difference between success and failure in the separation of the sample. A person of ordinary skill in the art also appreciates that endogenous contaminates (e.g., pectin, pulp, pigments, sugars, or other compounds with hydroxyl groups (—OH), etc.) within the sample can interfere with or impede the chromatographic process (e.g., one using Dowex® Monosphere® 99CA/320 Separation Resin) of the sample. The contaminates can cover or bind to the active sites on the resin, compete with the target compound for the active sites, clog the resin beads or column, and/or degrade the resin beads, etc. The differences in the chromatographic parameters can mean the difference in separating the sample into sharp individual compound peaks, a big broad peak with mixed compounds, a non-descript peak, or not being able to separate the sample at all.

The chromatographic separation of solution of pure water and two pure carbohydrates and the chromatographic separation of a solution containing a complex mixture of unique chemical compounds (contaminates) are totally different. For instance, fruit juices have a number of endogenous compounds that can interfere with the chromatographic separation of the juice. The endogenous compounds include but are not limited to pectin, pulp, flavor oils, pigments, sugars, etc.

Various minerals (e.g., ions) may be added to the feed stream to bind with active sites of the endogenous compounds of the fruit juice so as to reduce an interaction with the resin.

Calcium, a divalent cation, is commonly added to a solution to thicken, form a gel, or flocculate suspended compounds. Calcium ions may also be bound to a physically immobile matrix. In such an instance, one positive charge (of the Ca⁺²) forms a bond with the matrix (e.g., resin), while the other positive charge interacts with the other charged particles or particles containing hydroxyl groups. Calcium ions may be added to solution to remove suspended particles by forming linkages between two suspended particles resulting is a larger complex. As the particles increase in size, they fall out of solution.

The binding constant of the interaction between the calcium ions and other particles dictates the strength of the bond. Bond strength ranges from weak, medium, and strong. Ionic bonds are electrovalent bonds and form from the electrostatic attraction between two oppositely charged ions (atoms). Ionic bonds transfer electrons from one ion to the other to fill the valence shells. Covalent bonds are chemical bonds and form between two atoms where they share electrons and form full shared valence shells.

Fruit pectins (including citrus pectins) are used in the food industry as a gelling agent, thickener, and emulsifying agent. Fruit pectins are heterosaccharides and are divided, by their degree of esterification, into low methoxy pectin and high methoxy pectin. These two types of pectin form a gel with different mechanisms. Low methoxy pectins are used in the food industry to produce low sugar jams and jellies since they do not require sugar to create gels. However, low methoxy pectins require calcium (reactive with calcium) to produce a gel. On the other hand, high methoxy pectin requires a high sugar concentration to gel. Citrus pectins are known to react with calcium and produce good strong gels.

Pectins are composed of long chains of sugar molecules. They are primarily made up of α-(1-4)-linked D-galacturonic acid (>74%) but also contain rhamnose, arabinose, galactose, xylose, and other sugar molecules. The pectin sugar molecules as well as the fructose and glucose molecules contain hydroxyl (—OH) functional groups which are attracted to the calcium ions in the resin-calcium complex. The binding constants for the individual sugar molecules as well as the polysaccharides need to be determined to see how they react with the resin. Once the binding constants are determined, it also needs to be determined how they will interact with the sugars (e.g., glucose and fructose) in the chromatographic separation juice sample. At least the following possibilities exist:
1. The sugars of the pectin will irreversibly bind to the calcium.
2. The sugars in the pectin will be attracted to the calcium-resin complex but not be bound to the resin.
3. The pectin will have not any interaction with the active site on the resin beads.
4. On a physical level, the pectin could also cover active sites without reacting with the active site, clog the resin beads, and/or clog the column.

Plant fibers are primarily composed of cellulose and hemicellulose and are known to have some functional properties including water holding capacity, viscosity, gel forming, and cation exchange capacity dietary fiber. Orange juice pulp is composed of non-starch polysaccharides which include cellulose, (linear chains of B(1-4)linkage of glucose molecules), hemicelluloses, (linear chains of B(1-4 linkage) and branched chain (α-(1-3 linkage) of sugars including glucose, xylose, mannose, galactose, rhamnose, arabinose, and lignin cross-linked phenol polymers. Lignins are not composed of sugar molecules like cellulose and hemicelluloses, but the monomers still contain hydroxyl groups (—OH) which may be attracted to the Dowex® Monosphere® 99CA/320 Separation Resin.

Citrus oils (essential oils) are produced by citrus fruits in cells located in the fruit rind. The citrus juices that have flavor oils include orange, tangerine, grapefruit, etc. The composition of flavor oils varies with the type of fruit and variety. Orange flavor oils include several hundred organic compounds as analyzed by gas chromatography. Most of the flavor compounds belong to the terpene family including d-limonene. The other compounds include acids, aldehydes, and alcohols including octanal, decanal, and 1-octanol. Since aldehydes and alcohols also contain hydroxyl (—OH) groups, they may be attracted to the resin (resin complex is attracted to hydroxyl group on fructose and glucose) and inhibit or interfere with the separation of the sugars in the fruit juice. Other compounds in citrus fruits may include pinene, sabinene, myrcene, linalool, carene, etc.

### Benefits to the Consumer

A beverage containing fruit juice components product, water, and a high intensity natural and/or artificial sweetener (e.g., sucralose, stevia, or the like) produces a Fruit Juice Beverage (meets the standard identify) that is on par in sensory evaluations to its standard juice counterpart. Notably, the Fruit Juice Beverage will contain most of the vitamins, minerals, and other beneficial compounds of Fruit Juice without all the calories from sugar. Flavors and other ingredients may be added to increase the sensory characteristics of the fruit juice beverage. Citrus pectin or some other carbohydrate (gums, etc.) may be added to provide additional viscosity and a desired mouth-feel.

Juice consumption has been declining, in part, due to the relatively high calories of the beverage. A lower calorie product will allow consumers the opportunity to consume Orange Fruit Juice Beverages, using orange juice components product, with the goodness of “Orange Juice” and without the worry of the additional calories of “Orange Juice.” In the present disclosure, it should be understood that the terms “Orange Juice” and “Orange Juice Concentrate” are used to signify the standard of identity for the liquid contents extracted from oranges. Some of the benefits of the present process to the consumer are as follows.
Low calorie “Orange Fruit Juice Beverage”
Low sugar “Orange Fruit Juice Beverage”
“Orange Fruit Juice Beverage” similar in nutrition to “Orange Juice” but without all the sugar or calories
Higher quality “Orange Juice concentrates and beverages”
Ability to drink more “Orange Juice” containing products

### Benefits to the Manufacturer

Fruit juice components product can be used to produce fruit juice components product concentrates (e.g., for Fruit Juice Beverages), fruit juice components product flavorings (e.g., for beverages, etc.), and fruit juice components product ingredient components (e.g., for candies, etc.). Conventionally, concentrating standard sugar-containing products can be relatively expensive due, in part, to the high-sugar content resulting in high viscosity and high-energy requirements. By using fruit juice components product (which contain a lower amount of soluble solids), the energy requirement for processing will be significantly reduced. Less energy is required to concentrate low soluble solid solutions versus high soluble solid solutions. This thermal processing savings can range from about 10% to about 50% or even higher for operating costs. The resulting fruit juice components product concentrate can be recombined with water and a high intensity sweetener to produce low-calorie beverages. In addition, fruit juice components product storage and shipping costs (frozen and refrigerated) for single strength and concentrate are significantly reduced as a result of the sugar reduction. This savings can range from about 10% to about 70% or even higher.

The following are some of the benefits of the present process to the manufacturer.
Marketing of a new “Fruit Juice Beverage” that is similar in nutrition to standard “Juice” but without all the sugar or calories
Marketing of a new low calorie “Fruit Juice Beverage” with consumer benefits
Marketing of a new low sugar “Fruit Juice Beverage” with consumer benefits
Lower processing costs during the concentration process
Lower frozen storage costs
Lower frozen shipment costs
Marketing of new products such as, for example,
   Fruit beverages
   Low sugar/low calorie “Fruit Juice Beverage” with High Intensity Sweeteners
   Low sugar/low calorie “Fruit Flavor”
   Low sugar/low calorie “Fruit Ingredient”

### Experimental Overview

Discussed herein is an experiment that was divided into five trials. Each trial used an increasingly more complex fruit juice. The first trial involved separating a simulated juice, of an aqueous fructose solution containing a blue dye, into an aqueous blue dye solution (blue dye and distilled water) peak and an aqueous fructose solution (purified fructose and distilled water) peak using Dowex® Monosphere® 99CA/320 Separation Resin. The water was degassed, distilled, pure and free of ions. The fructose was ion-free, purified, and absent of contaminates. A number of parameters including sample size, column diameter, column height, and flow rate were varied to test and determine the process. The sample size was evaluated from 10 ml to 40 mls. Two column diameters (1.9 cm and 3 cm) were investigated. The column height was studied with a range of 30 cm to 100 cm. The flow was studied from 1 ml per min to 10 mls per minute.

The second trial involved separating an apple juice sample into an apple “juice components product” (hereinafter, “JCP”) peak and a sugar peak using Dowex® Monosphere® 99CA/320 Separation Resin. The apple juice sample contained free ions, pectin, fructose, glucose, sucrose, acids, flavor compounds, aroma compounds, and other endogenous compounds (contaminates). Apple juice contains glucose (about 27%), fructose (about 60%), and sucrose (about 13%). Free ions are known to reduce the chromatographic separation of the sample, and pectins are very reactive with calcium. The resin used is a calcium-resin complex. It was unknown how the free ions, calcium sensitive pectins, and the endogenous compounds would affect the chromatographic process. The water was degassed, distilled, pure and free of ions. A number of parameters including apple juice sample size, column diameter, column height, flow rate, and pH were varied to test and determine the process. The apple juice sample size was evaluated from 10 ml to 40 mls. The column height was studied with a range of 30 cm to 100 cm. The flow was studied from 1 ml per min to a high of 10 mls per minute. The pH of the apple juice was investigated from a pH of 2 to 6.

The third trial involved separating a concord grape juice sample into a concord grape JCP peak and a sugar peak using Dowex® Monosphere® 99CA/320 Separation Resin. The concord grape juice sample contained free ions, pectins, pigments, fructose, glucose, acids, flavor compounds, aroma compounds, and other endogenous compounds (contaminates). Concord grape juice contains glucose (about 48%), fructose (about 52%) and sucrose (less than 1%). Free ions are known to reduce the chromatographic separation of the sample, and pectins are very reactive with calcium. The resin used is a calcium-resin complex. It was unknown how the free ions, calcium sensitive pectins, pigments, and the endogenous compounds would affect the chromatographic process. The water was degassed, distilled, pure and free of ions. The optimal process parameters (sample size, flow rate, column diameter and height) of the apple juice were used with the concord grape juice sample. However, pH adjustment and the addition of ions were varied to test and determine the process.

The fourth trial involved separating an orange juice sample into an orange JCP peak and a sugar peak using Dowex® Monosphere® 99CA/320 Separation Resin. This trial was designed to see the effect that a more complex (more pectin, pulp, orange flavor oils, and other contaminates) fruit juice has on the chromatographic separation of an orange juice sample into an orange JCP peak and a sugar peak. Orange juice contains glucose (about 26%), fructose (about 28%), and sucrose (about 46%). The orange juice used in the trial was significantly more viscous (thicker) and had a higher concentration of complex mixtures of contaminates than the apple or concord grape juice sample used in the second or third trial. The orange juice sample contained free ions, pulp, pectin, flavor oils, fructose, glucose, sucrose, acids, B-carotene (pigment), flavor compounds, aroma compounds, and other endogenous compounds (contaminates). Free ions are known to reduce the chromatographic separation of the sample, and pectins are very reactive with calcium. Pulp is composed of monomers with functional hydroxyl groups and may interact with the calcium-resin complex. It was unknown how the free ions, higher concentration of calcium sensitive pectins, pulp, flavor oils, B-carotene (pigment), and the endogenous compounds would affect the chromatographic process. The water was degassed, distilled, pure and free of ions. A number of parameters including orange juice sample size, column height, flow rate, and pH were varied to test and determine the process. The orange juice sample size was evaluated from 10 ml to 40 mls. The column height was studied with a range of 30 cm to 100 cm. The flow was studied from 1 ml to 10 mls per minute. The eluent headspace was increased to achieve the highest flow rates and for the largest sample size. The pH of the orange juice was investigated from a pH of 2 to a pH of 6.

The fifth trial involved separating an orange juice with chelator (e.g., added EDTA) sample into an orange juice with added EDTA JCP peak and a sugar peak using Dowex® Monosphere® 99CA/320 Separation Resin. This trial was designed to evaluate the effect that a chelator added to the sample has on the separation of an orange juice sample into an orange with chelator JCP peak and the sugar peak. The orange juice sample contained free ions, pulp, pectin, orange flavor oils, fructose, glucose, sucrose, acids, flavor compounds, aroma compounds, and other endogenous compounds (contaminates). Orange juice contains glucose (about 26%), fructose (about 28%), and sucrose (about 46%). Free ions are known to reduce the chromatographic separation of the sample, and pectins are very reactive with calcium. Endogenous compounds with hydroxyl groups may interact with the resin. The resin used is a calcium-resin complex. It was unknown how the addition of a chelator would affect the chromatographic process. The water was degassed, distilled, pure and free of ions. As noted above, a chelator (e.g., EDTA) was added to the orange juice sample. The chelator was added to bind the free ions, to reduce the concentration of the free ions, and/or to make the free ions less reactive. By chelating the free ions, they are no longer able to dissociate the calcium from the resin-calcium complex, thus protecting the calcium-resin complex. Otherwise, the dissociation of the calcium from the resin-calcium complex would make the resin no longer capable of chromatographic separation of the sample. The optimal parameters from the fourth trial (orange juice) were used for the orange juice with chelator (e.g., EDTA) fifth trial.

### Experimental Procedure

### Resin Conditioning

Dowex® Monosphere® 99CA/320 Separation Resin (Supelco Inc.) was conditioned by transferring new moist resin to a glass container with degassed distilled water. The distilled water was degassed by placing it under vacuum for 24 hours with intermittent swirling of the liquid before being used. The resin was mixed slowly in the 4 volumes of room temperature degassed distilled (ion-free) water and stored overnight. After 12 hours of conditioning the resin was gently stirred and allowed to set for 3 minutes before the supernatant was decanted to remove the fines. The resin was washed with 3 volumes of degassed distilled water, set for 3 minutes, and the supernatant was decanted. The procedure was repeated three times before the supernatant was clear and absent of fines, at which point the resin was considered conditioned.

### Column Preparation

Fifty milliliters of degassed distilled water was added to a column. A plastic screen was placed at the bottom of the exit tube of the column to prevent the resin from clogging the outlet tube. The distilled water was degassed by maintaining the distilled under a vacuum for 24 hours with intermittent swirling of the liquid. Conditioned Dowex® Monosphere® 99CA/320 Separation Resin slurry was added to a column containing the degassed distilled water. The flow rate of the eluent was maintained during the entire pour in order to achieve a homogeneously packed column. The concentration of the resin slurry was also maintained during the pour to achieve a homogenous density of the packed column. The column was absent “pouring layers” or high and low density pockets within the column which would alter the chromatography of the sample. The water level was maintained above the resin surface throughout this pouring process. The final resin bed height was 63.5 cm with a diameter of 3 cm. A plastic mesh circle was placed on the surface of the resin in the column. The plastic mesh circle was added to reduce a disturbance of the resin bed when the sample was applied.

A test solution (blue dye and distilled water) was applied to the column and eluted through the column to test the homogeneousness of the resin bed. As the blue color moved through the bed, it would show “layers” and “dense and less dense” locations within the column. Columns with irregularities were not used since irregularities interfere with the elution of the sample. In addition, columns that developed air bubbles either before or during the separation of the samples were dismantled and the resin was reconditioned, since air bubbles interfere with the elution of the samples. Also, if the bed height increased or decreased during the trial, then the results were discarded and the trial was repeated with a new column. Furthermore, if the flow rate significantly increased or decreased during the trial, then the results were discarded and the trial was repeated with a new column.

### Sample Preparation

Five samples were prepared: 1) simulated juice, 2) apple juice concentrate, 3) concord grape juice concentrate, 4) orange juice concentrate, and 5) orange juice concentrate with a chelator (e.g., EDTA). None of the juice concentrates were treated to remove the native free ions.

The first sample was a simulated juice containing a fructose solution (a simple carbohydrate and distilled water solution) with a blue dye. The simulated juice was designed to simulate a simple, purified, and contaminate-free juice, without ions, pulp, pectin, flavor oils, pigments, acids, glucose, sucrose flavor compounds, aroma compounds, or other materials (contaminates) that interfere with the chromatographic separation. The solution was prepared by combining 144 gm of purified crystalline fructose; 200 ml of room temperature degassed distilled water (ion-free), and one drop of blue color (McCormick Neon Food Colors). The solution was manually stirred until the crystalline fructose was dissolved without incorporating air into the sample. The resulting solution had a brix of 42.3° as measured with a hand held refractometer (Epic Inc., 30%-60%). All brix measurements in this trial were uncorrected for acid. The pH of the solution was not adjusted. The sample was degassed by placing it under a vacuum for 2 hours before being used. The column, eluent, and sample were at room temperature before the sample was applied on the column.

The second sample was an apple juice concentrate. Apple juice was evaluated to see if a complex fruit juice sample containing free ions, pectin, fructose, glucose, sucrose, brown pigment (phenolic compounds oxidized by polyphenol oxidase enzyme), acids, flavor compounds, aroma compounds, and other endogenous compounds (contaminates) could be chromatographically separated into an apple JCP peak and a sugar peak. The apple juice sample was prepared by combining room temperature apple juice concentrate (Langers 100% Apple Juice) and room temperature, degassed distilled (ion-free) water. The apple juice concentrate and distilled water was stirred to produce a homogenous sample without incorporating air into the sample. The concentrate was diluted with water since the apple juice concentrate was too viscous. The initial brix of the Apple Juice sample was determined to be about 50° brix as measured with a hand held refractometer (Epic Inc. 30%-60%). The apple juice sample was divided into three hundred mls aliquots and the pH of the samples was adjusted. Once the pH was adjusted, degassed distilled water was added to the apple juice sample to achieve a 42.3 Brix. A range of pH of the apple juice solutions were evaluated on the chromatographic separation of the apple juice sample. The samples were degassed by placing it under a vacuum for 2 hours before being used. The column, eluent, and samples were at room temperature before the sample was applied on the column.

The third sample was a concord grape juice concentrate. Concord grape juice was evaluated to see if a more complex fruit juice sample containing free ions, pectin, pigments, fructose, glucose, acids, flavor compounds, aroma compounds, and other unique endogenous compounds (contaminates) could be chromatographically separated into a concord grape juice JCP peak and a sugar peak. Concord grape juice contains fructose, glucose and may have a trace amount of sucrose. Concord grape juice also has different endogenous compounds versus apple juice. The sample was prepared by combining concord grape juice concentrate (Welch's 100% grape juice) (64° brix) that was at room temperature with degassed distilled (ion free) water. The combination was stirred to maintain a homogenous sample without incorporating air into the sample. The diluted concord grape juice sample was divided into 300 mls aliquots and the pH adjusted. Once the pH was adjusted, degassed distilled water was added to the orange juice sample to achieve 42.0 Brix measured with a hand held refractometer (Epic Inc., 30%-60%). A range of pH of the concord grape juice solutions was evaluated to see if it would have an effect on the chromatographic separation of the concord grape juice sample. The sample was degassed by placing it under a vacuum for 2 hours before being used. The column, eluent, and samples were at room temperature before the sample was applied on the column.

The fourth sample was a clarified orange juice concentrate. Orange juice was evaluated to see if a more complex and more viscous fruit juice sample containing more pulp and pectin, free ions, flavor oils, acids, flavor oils, aroma compounds, and other endogenous compounds (contaminates) could be chromatographically separated into an orange JCP peak and a sugar peak. Orange juice contains unique endogenous compounds as compared with apple and concord grape juice.

Initially, a low pulp orange juice concentrate was diluted with degassed distilled water, mixed, and passed through a filter to produce a low pulp and low pectin orange juice sample. However, the orange juice sample was too thick and the process was unsuccessful.

Next, a commercially available de-pulped orange juice concentrates was evaluated. The sample was diluted with degassed distilled water, mixed, filtered, and applied on the column. However, the diluted orange juice sample clogged the column. The commercial de-pulped orange juice was diluted to single strength (11.8 brix) and evaluated on the column. The single strength juice did not clog the column and passed through easily. However, the resulting fractions were too dilute to be evaluated properly.

After the first two trials, it was observed that the resin was being damaged by the orange juice concentrates. A dilute solution of orange oils was mixed with the resin overnight and evaluated. The resin was damaged by the orange oils, and as a result, the following orange juice concentrates were without flavor (orange oils) added back to the juice (without flavor add back).

Subsequently, a commercially available clarified, without flavor add back (flavor oils), orange juice concentrate (clarified by passing it through a membrane filtration system) was evaluated. However, the juice concentrate was too thick to be applied directly on the column. As a result, the juice was brought to room temperature, diluted with water, and then applied to the column. In addition, by increasing the headspace of eluent (increased column pressure), the sample passed through the column. The clarified orange juice was used subsequently in the trials.

The sample for the fourth trial was prepared by combining Clarified Orange Juice (reduced pulp and pectin) concentrate (68.2° brix) (Cargill Inc.) and degassed distilled (ion free) water. The combination was stirred to maintain a homogenous sample without incorporating air into the sample. The diluted orange juice sample was divided into 300 mls aliquots, and the pH was adjusted. Once the pH was adjusted, degassed distilled water was added to the orange juice sample to achieve 42.0 Brix measured with a hand held refractometer (Epic Inc., 30%-60%). A range of pH of the orange juice solutions was evaluated to see if it would have an effect on the chromatographic separation of the orange juice sample. The sample was degassed by placing it under a vacuum for 2 hours before being used. Five hundred mls of warm (80-85° F.) degassed distilled water was passed through the column to increase the temperature of the column. The sample was warmed to 80-85° F. to reduce the sample viscosity before it was applied on the column. The eluent was also warmed to 80-85° F.

The fifth sample was a clarified orange juice (without flavor add back) with an added chelator (e.g., EDTA). Orange juice with EDTA was evaluated to see if adding EDTA to a complex and viscous fruit juice sample containing high concentrations of pulp, pectin, free ions, flavor oils, B-Carotene (pigment), flavor compounds, aroma compounds, and other endogenous compounds (contaminates) could be chromatographically separated into an orange with EDTA JCP peak and a sugar peak. EDTA was added to the orange juice to bind the free ions therein. The sample was prepared by combining Clarified Orange Juice (without flavor add back) (reduced pulp and pectin) concentrate (Cargill Inc.) with room temperature, degassed, and distilled water, and the combination was stirred to maintain a homogenous sample without incorporating air into the sample. The orange juice concentrate (68.2° brix) was also diluted with degassed distilled water to reduce its viscosity. The diluted orange juice sample was divided into 300 mls aliquots, the EDTA was added, and the pH adjusted. The EDTA was in the acid form. Once the pH was adjusted, distilled water was added to the orange juice sample to achieve a 42.0 Brix measured with a hand held refractometer (Epic Inc., 30%-60%). A range of pH of the orange juice with EDTA solution was evaluated to see the effect it would have on the chromatographic separation of the sample. The sample was degassed by placing it under a vacuum for 2 hours before being used. Five hundred mls of warm (80-85° F.) degassed distilled water was passed through the column to increase the temperature of the column. The sample was warmed to 80-85° F. to reduce the sample viscosity before it was applied on the column. The eluent was also warmed to 80-85° F.

### Experimental Results

### Simulated Juice Results

In the first trial, the objective was to chromatographically separate a simulated juice, composed of an aqueous fructose (simple carbohydrate solution) and blue color sample, into an aqueous blue color peak and an aqueous fructose (sugar) peak. The fructose was ion-free, purified, and absent of contaminates. The results showed the separation of the simulated juice into a semi-sharp blue color peak and a semi-broad fructose peak. A number of chromatography perimeters were evaluated (column diameter, sample size, flow rate, and column (bed) height) to optimize the process.

Column diameters (1.9 cm and 3 cm) were evaluated for the separation of the simulated juice solution. The smaller 1.9 cm diameter column gave sharper peaks, but the sample size was too small to be analyzed (quantitative) for the blue peak. As a result, all of the remaining trials were conducted with the larger 3 cm diameter column.

Sample size was evaluated from 10 to 50 mls. The smaller sample size (10 mls) did not give good visual results of the blue color peak. The larger sample size with high flow rate resulted in a big, wide chromatographic peak. However, the medium and large sample size with medium flow rate produced good peaks.

Column (bed) heights were evaluated from 40 cm to 100 cm. The shorter column did not produce a good separation of the blue color peak and fructose peak. The 100 cm column with high flow rate produced large, broad blue color and fructose peaks. The medium and large sample size and medium and tall columns with medium flow rate produced good peaks. The low sample size with the medium and large column height with high flow rates produced very dilute samples. In addition, the blue color peak was broad and the color was too light to quantify. The optimal bed height was 63-100 cm, which produced separate, distinct peaks.

Flow rates were evaluated from 1 to 10 mls per minute. The slower flow rate was too slow and the chromatography took too long. The fastest flow rates were too fast and distorted the chromatographic peaks. The optimal flow rate was 3.7-6.0 mls per minute.

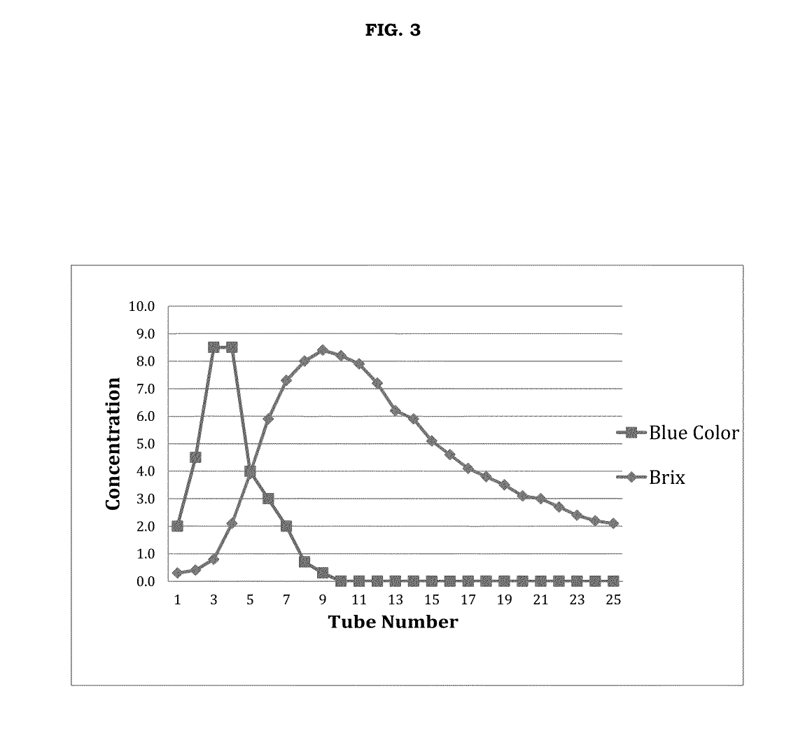

FIG. 3 is a graph of the results of a chromatographic separation of a simulated juice solution according to example embodiments. Referring to FIG. 3, the simulated juice solution was chromatographically separated into two peaks. The first peak was composed of the blue color solution, and the second peak was a sugar peak (fructose peak). The blue color exited the column in a well-defined bell curve, while the fructose produced a positively skewed curve. Tubes 3 and 4 showed the maximum blue color (visual), while tube 9 showed the highest brix, as measured with a hand held refractometer (Reichert model 10430 0-30 Brix). The trial was run in triplicate and had good reproducibility. The average of the three data points is shown infra in Table 1.

### Apple Juice Results

In the second trial, the objective was to chromatographically separate an apple juice sample into an apple JCP peak and a sugar peak. The results showed the separation of the apple juice sample which contained free ions, pectin, fructose, glucose, sucrose, acids, flavor compounds, aroma compounds, and other endogenous compounds (contaminates) into a semi-sharp apple JCP peak and a semi-broad sugar (fructose, glucose, and sucrose) peak. A number of chromatography perimeters were evaluated, including sample size, flow rate, column (bed) height, and pH.

Sample size was evaluated from 10 to 50 mls. The smaller sample size (10 mls) did not give good visual or sensory results of the apple JCP peak. The medium and large sample size with medium flow resulted in good apple JCP peaks.

Column (bed) heights were evaluated from 40 cm to 100 cm. The shorter column did not produce a good separation of the apple JCP peak and the sugar peak. The medium and taller columns with medium sample size produced good peaks. The optimal bed height was 63-100 cm, which produced separate, distinct peaks.

Flow rates were evaluated from 1 to 10 mls per minute. The slower flow rate was too slow and the chromatograms took too long. The fastest flow rates were too fast and distorted both of the chromatographic peaks. The medium and large sample size and medium and tall column with medium flow rate produced good peaks. Based on the results, the optimal flow rate was found to be 3.7-6.0 mls per minute.

The pH of the apple juice samples was evaluated from 2 to 6. The pH of the sample affected the separation of the apple juice sample and the chromatographic shapes of the apple JCP peak and the sugar peak.

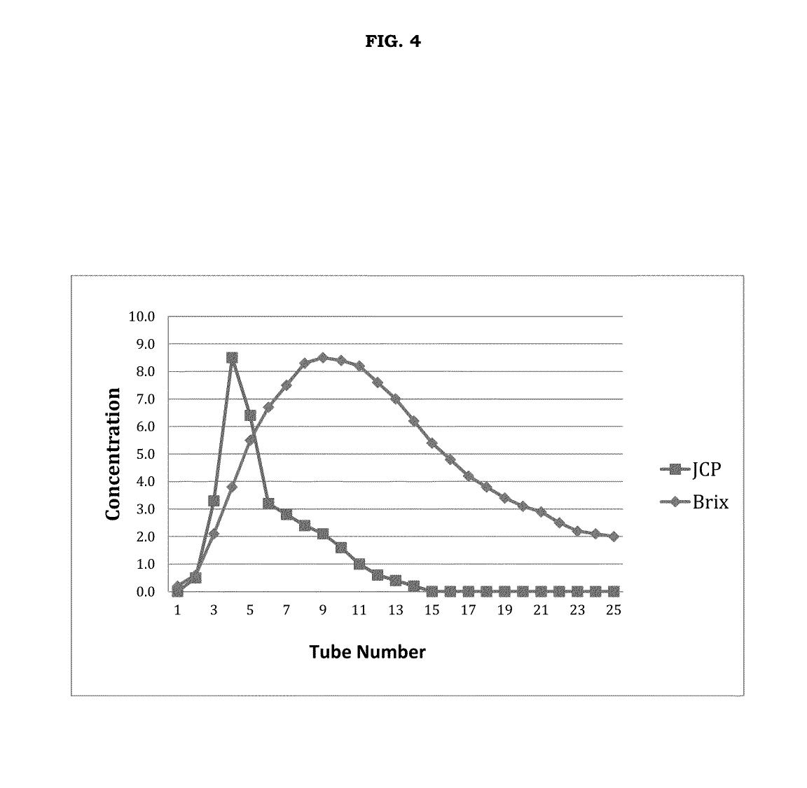

FIG. 4 is a graph of the results of a chromatographic separation of apple juice according to example embodiments. Referring to FIG. 4, the apple juice is separated into two chromatographic peaks. The first peak was composed of the apple JCP peak, and the second peak was the sugar (fructose, glucose, and sucrose) peak. Even though the apple juice sample contained significant quantities of free ions, pectin, glucose, sucrose, flavors, acids, and other endogenous compounds (contaminates), it was separated into an apple JCP peak and a broad sugar peak. In particular, the sugars (e.g., fructose, glucose, sucrose) eluted in a single peak, rather than in individual sugar peaks. In addition, the apple JCP peak eluted about 10 mls later than the blue color peak from the first trial (simulated juice) above due to the contaminates in the apple juice sample. The contaminates interfered with the chromatography separation of the sample. The apple JCP produced a well-defined bell curve, while the sugar peak (fructose, glucose, sucrose) produced a positively skewed curve. Tube 4 showed the maximum color, acidity, and flavor (sensory evaluation), while tube 9 showed the highest brix, as measured with a hand held refractometer (Reichert model 10430 0-30 Brix). The trial was run in triplicate and had good reproducibility. The average of the three data points is shown infra in Table 1.

### Concord Grape Juice Results

In the third trial, the objective was to chromatographically separate a concord grape juice sample into a concord grape JCP peak and a sugar peak. The results showed the separation of the concord grape sample which contained free ions, pectin, pigments (colors), fructose, glucose, acids, flavor compounds, aroma compounds, and other endogenous compounds (contaminates) into a semi-sharp concord grape juice JCP peak and a semi-broad sugar (fructose and glucose) peak. The pH and the addition of ions (cations, anions) were evaluated on the chromatographic separation of concord grape juice. The other chromatographic process parameters (sample size, flow rate, column diameter and height) of the apple juice were used with the concord grape juice sample.

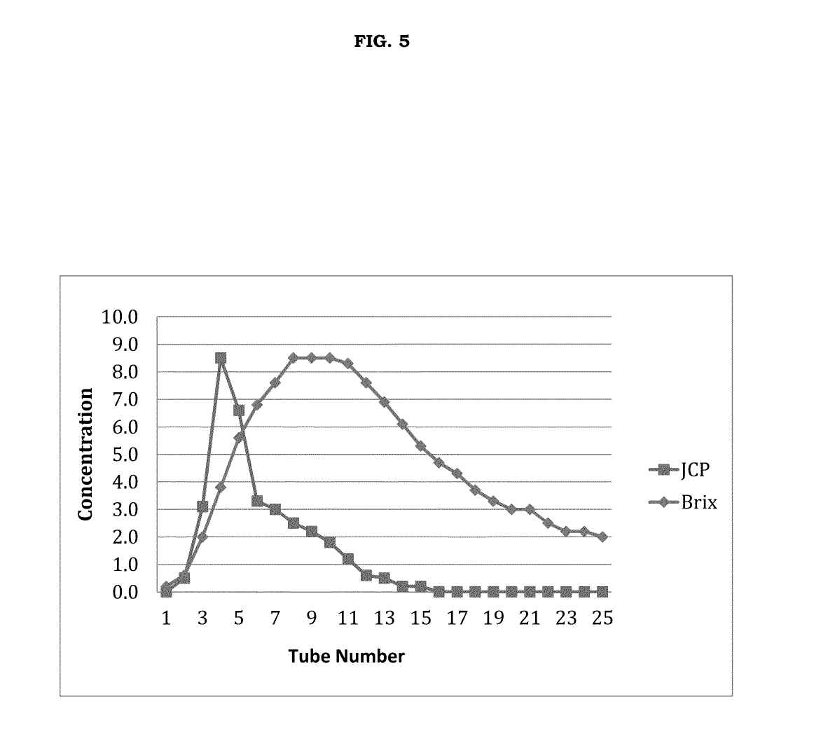

FIG. 5 is a graph of the results of a chromatographic separation of concord grape juice according to example embodiments. Referring to FIG. 5, the concord grape juice was separated into two chromatographic peaks. The first peak was composed of the concord grape JCP peak, and the second peak was the sugar (fructose and glucose) peak. During the process, the native concord grape juice pigment was removed from the concord grape juice stream by the resin. The blue pigment became bound by the resin. Extensive trials were needed to determine the optimal pretreatment process of the concord grape juice to keep the pigment from being removed from the fruit juice stream and being bound to the resin. By increasing the pH and adding ions (i.e., calcium chloride) to the grape juice sample, it was possible to significantly reduce the amount of pigment from binding to the resin and staying in the concord grape juice stream.

The concord grape juice sample was separated into two chromatographic peaks. The first peak was composed of the concord grape JCP peak, and the second peak was the sugar (fructose and glucose) peak. Even though the concord grape juice sample contained significant quantities of free ions, pectin, glucose, flavors, acids, and other endogenous compounds (contaminates), it was separated into a concord grape JCP peak and a broad single sugar (fructose and glucose) peak, rather than in individual sugar peaks. In addition, the concord grape JCP peak eluted about 10 mls later than the blue color peak from the first trial (simulated juice) due to contaminates in the concord grape juice sample. The concord grape JCP produced a well-defined bell curve, while the sugar peak (fructose and glucose) produced a positively skewed curve. Tube 4 showed the maximum color, acidity, and flavor (sensory evaluation), while tubes 8, 9, and 10 showed the highest brix, as measured with a hand held refractometer (Reichert model 10430 0-30 Brix). The trial was run in triplicate and had good reproducibility. The average of the three data points is shown infra in Table 1.

### Orange Juice Results

In the fourth trial, the objective was to chromatographically separate an orange juice (without native flavor oils) sample into an orange JCP peak and a sugar peak. The orange juice sample was significantly more viscous (thicker) and had a higher concentration of complex mixtures of contaminates than the apple or concord grape juice samples. The orange juice sample contained free ions, pulp, pectin, fructose, glucose, sucrose, acids, flavor compounds, aroma compounds, and other endogenous compounds (contaminates). The results showed the separation of the orange juice sample into an orange JCP peak and the sugar (fructose, glucose, and sucrose) peak.

A number of trials were needed to determine the optimal pretreatment of the orange juice. The first sample was a low pulp orange juice concentrate. The product was diluted with water to 42 brix and passed through a filter. However, the first orange juice sample clogged the column. The second sample involved using a commercially-available orange juice concentrate without pulp and some pectin removed. The product was diluted with distilled water to 42 brix and filtered. However, the second orange juice sample also clogged the column. The third sample involved sourcing a commercial-available clarified orange juice concentrate. This sample was commercially passed through a membrane filtration system to remove almost all of the pulp and some of the pectin. The clarified orange juice concentrate was used in the remaining trials.

A number of chromatography perimeters were evaluated, including sample size, flow rate, column (bed) height, and pH, in connection with the clarified orange juice samples.

Sample size was evaluated from 10 to 50 mls. The smaller sample size (10 mls) did not give good visual or sensory results of the orange JCP peak. However, it was better than the apple juice sample. The larger sample size (40-50 mls) clogged the column since the sample was too large, thick, and viscous. Even increasing the liquid level of the column to increase the column pressure did not resolve the problem. Based on the results, the optimal sample size was found to be 32 mls.

Column (bed) heights were evaluated from 40 cm to 100 cm. The shorter column did not produce a good separation of the orange JCP peak and the sugar (fructose, glucose and sucrose) peak. The 100 cm column with the small sample size produced large, broad peaks. The optimal bed height was 63 cm, which produced two separate, distinct peaks.

Flow rates were evaluated from 1 to 10 mls/minute. The slower flow rate was too slow and the chromatograms took too long. The fastest flow rates were too fast and distorted the chromatographic peaks. The medium and large sample size and tall column clogged and inhibited the flow. Based on the results, the optimal flow rate was found to be 3.7 mls per minute with the medium column.

The pH of the orange juice samples were evaluated from a pH of 2 to 6. The pH of the sample affected the separation of the orange juice sample and the chromatographic shapes of the orange juice peak and the sugar peak.

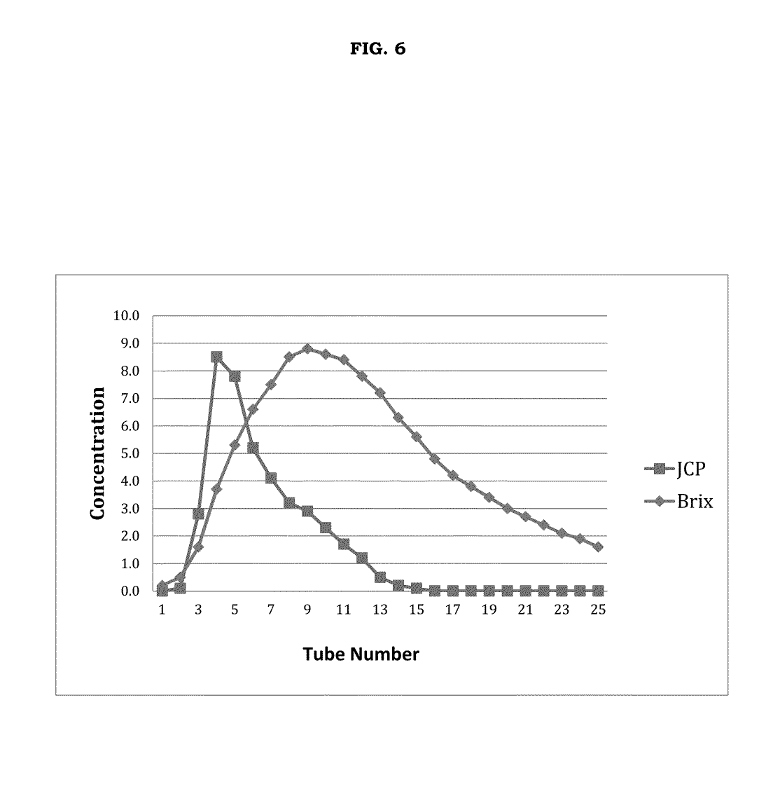

FIG. 6 is a graph of the results of a chromatographic separation of orange juice according to example embodiments. Referring to FIG. 6, the orange juice was separated into two chromatographic peaks. The first peak was composed of the orange JCP peak, and the second peak was the sugar (fructose, glucose, and sucrose) peak. Orange juice had the highest concentration of pulp, pectin, orange oils, and other contaminates. The orange JCP eluted about 15 mls later than the blue peak in the first trial and about 5 mls after the apple JCP peak in the second trial. The sugar eluted in a single peak instead of individual sugar peaks. The orange JCP produced a well-defined bell curve, while the sugar peak (fructose, glucose, sucrose) produced a positively skewed curve. Tube 4 showed the maximum orange color, orange aroma, acids, orange flavor, and other juice components, as measured by sensory evaluation (qualitative data), while tube 9 showed the highest brix, as measured with a hand held refractometer (Reichert model 10430 0-30 Brix). The trial was run in triplicate and had good reproducibility. The average of the three data points is shown infra in Table 1.

Orange Juice with Chelator Results

In the fifth trial, the objective was to chromatographically separate the orange juice with chelator (e.g., EDTA) sample into an orange juice with EDTA JCP peak and a sugar peak. The results showed the separation of the clarified orange juice with EDTA sample into an orange juice with EDTA JCP peak and a sugar (fructose, glucose, and sucrose) peak.

The same optimal sample size, column height, and flow rates from the orange juice trial were used for the orange juice with EDTA test. The pH of the orange juice with EDTA sample was evaluated from a pH of 2 to 6. The pH of the sample affected the separation and elution of the orange juice with EDTA sample and the chromatographic shapes of the orange juice with EDTA JCP peak and the sugar peak.

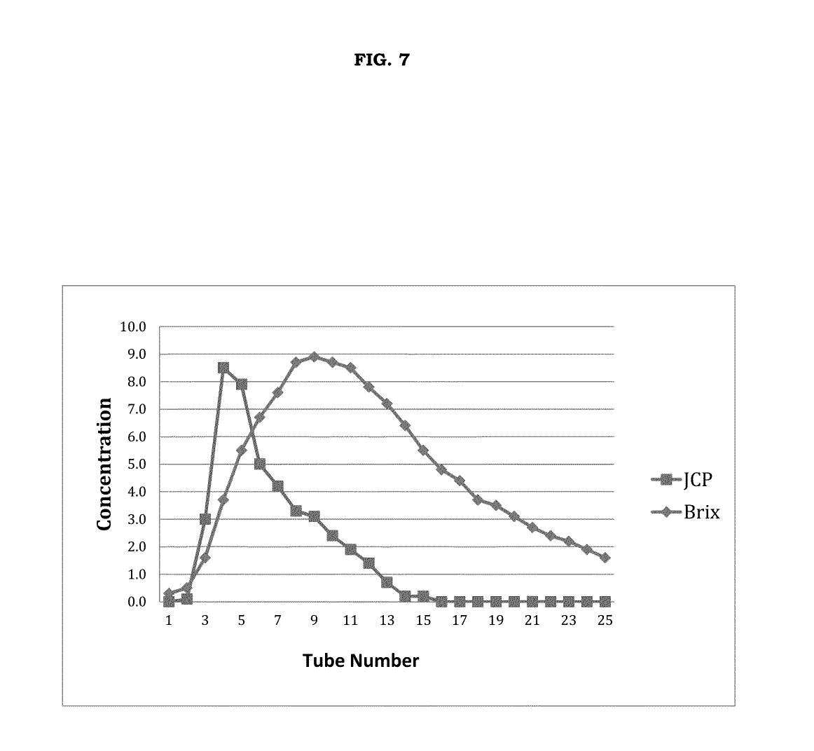

FIG. 7 is a graph of the results of a chromatographic separation of an orange juice with a chelator, wherein the chelator protected the resin complex, according to example embodiments. Referring to FIG. 7, the orange juice with chelator (e.g., EDTA) sample is separated into two chromatographic peaks. The first peak was composed of the orange with EDTA JCP peak and the second peak was the sugar (fructose, glucose, and sucrose) peak (Table 1). The orange with EDTA JCP peak produced a well-defined bell curve, while the sugar peak (fructose, glucose, sucrose) produced a positively skewed curve. Tube 4 showed the maximum orange color, orange flavor, orange aroma, acids, and other juice components, as measured by sensory evaluation (qualitative data). Tube 9 showed the highest brix, as measured with a hand held refractometer (Reichert model 10430 0-30 Brix). The trial was run in triplicate and had good reproducibility. Orange juice and orange juice with EDTA had similar chromatographic and sensory results. The average of the three data points is shown below in Table 1.

### Comparison of Chromatographic Results

The simulated fruit juice sample containing pure fructose and blue dye was separated into a pure fructose peak and a blue dye peak. The apple juice sample containing free ions, pectin, fructose, glucose, sucrose, acids, flavor compounds, aroma compounds, and other endogenous compounds (contaminates) was not separated into individual sharp peaks. The contaminates within the apple juices samples inhibited the three sugars from being separated into three individual sugar peaks. The endogenous compounds also affected the elution of the apple JCP peak. The apple JCP peak eluted about 6 mls after the blue color peak of the first trial. The contaminates (free ions, pectin, fructose, glucose, acids, flavor compounds, aroma compounds, and other endogenous compounds) in the concord grape juice prohibited fructose and glucose from separating into two individual sugar peaks. The sugars eluted as a single broad sugar peak. The concord grape JCP peak eluted 8 mls after the blue peak in the simulated juice trial. The orange juice sample contained free ions, pulp, pectin, fructose, glucose, sucrose, acids, flavor compounds, aroma compounds, and other endogenous compounds (contaminates). The orange juice sample was not separated into three individual sugar peaks (fructose, glucose, and sucrose) due to the endogenous contaminates. The orange JCP peak of the fourth trial and the orange with EDTA JCP peak of the fifth trial eluted about 9 mls after the blue color peak of the first trial and about 5 mls after the apple JCP peak of the second trial. The results show that the different composition of the sample (free ions, pulp, pectin, orange oils, fructose, glucose, sucrose, acids, flavor compounds, aroma compounds, and other endogenous contaminates) affected the chromatographic separation of the four samples versus the simulated juice sample. This shows that the compounds within the orange juice had a greater effect on the chromatography of the orange juice versus the simulated juice, apple juice, and concord grape juice trials. The orange juice not only delayed the peak but the peak shape was also altered. The blue color peak was a well-defined bell curve, while the apple JCP, concord grape JCP, orange JCP, and orange with EDTA JCP peaks were positively skewed. The sugar peaks (fructose; fructose, glucose, and sucrose; or fructose and glucose) produced a positively skewed curve.

TABLE 1
Brix* vs Blue Color and Fruit JCP

| | | | | | | Concord | | | | Orange | |
|---|---|---|---|---|---|---|---|---|---|---|---|
| | | Simulated | | Apple | | Grape | | Orange | | Juice + | |
| | | Juice | | Juice | | Juice | | Juice | | EDTA | |
| Tube | mL | Brix | Blue Color | Brix | JCP | Brix | JCP | Brix | JCP | Brix | JCP |
| 1 | 10 | 0.3 | 2.0 | 0.2 | 0.0 | 0.2 | 0.0 | 0.2 | 0.0 | 0.3 | 0.0 |
| 2 | 20 | 0.4 | 4.5 | 0.6 | 0.5 | 0.6 | 0.5 | 0.5 | 0.1 | 0.5 | 0.1 |
| 3 | 31 | 0.8 | 8.5 | 2.1 | 3.3 | 2.0 | 3.1 | 1.6 | 2.8 | 1.6 | 3.0 |
| 4 | 41 | 2.1 | 8.5 | 3.8 | 8.5 | 3.8 | 8.5 | 3.7 | 8.5 | 3.7 | 8.5 |
| 5 | 51 | 3.9 | 4.0 | 5.5 | 6.4 | 5.6 | 6.6 | 5.3 | 7.8 | 5.5 | 7.9 |
| 6 | 61 | 5.9 | 3.0 | 6.7 | 3.2 | 6.8 | 3.3 | 6.6 | 5.2 | 6.7 | 5.0 |
| 7 | 71 | 7.3 | 2.0 | 7.5 | 2.8 | 7.6 | 3.0 | 7.5 | 4.1 | 7.6 | 4.2 |
| 8 | 82 | 8.0 | 0.7 | 8.3 | 2.4 | 8.5 | 2.5 | 8.5 | 3.2 | 8.7 | 3.3 |
| 9 | 92 | 8.4 | 0.3 | 8.5 | 2.1 | 8.5 | 2.2 | 8.8 | 2.9 | 8.9 | 3.1 |
| 10 | 102 | 8.2 | 0.0 | 8.4 | 1.6 | 8.5 | 1.8 | 8.6 | 2.3 | 8.7 | 2.4 |
| 11 | 112 | 7.9 | 0.0 | 8.2 | 1.0 | 8.3 | 1.2 | 8.4 | 1.7 | 8.5 | 1.9 |
| 12 | 122 | 7.2 | 0.0 | 7.6 | 0.6 | 7.6 | 0.6 | 7.8 | 1.2 | 7.8 | 1.4 |
| 13 | 133 | 6.2 | 0.0 | 7.0 | 0.4 | 6.9 | 0.5 | 7.2 | 0.5 | 7.2 | 0.7 |
| 14 | 143 | 5.9 | 0.0 | 6.2 | 0.2 | 6.1 | 0.2 | 6.3 | 0.2 | 6.4 | 0.2 |
| 15 | 153 | 5.1 | 0.0 | 5.4 | 0.0 | 5.3 | 0.2 | 5.6 | 0.1 | 5.5 | 0.2 |
| 16 | 163 | 4.6 | 0.0 | 4.8 | 0.0 | 4.7 | 0.0 | 4.8 | 0.0 | 4.8 | 0.0 |
| 17 | 173 | 4.1 | 0.0 | 4.2 | 0.0 | 4.3 | 0.0 | 4.2 | 0.0 | 4.4 | 0.0 |
| 18 | 184 | 3.8 | 0.0 | 3.8 | 0.0 | 3.7 | 0.0 | 3.8 | 0.0 | 3.7 | 0.0 |
| 19 | 194 | 3.5 | 0.0 | 3.4 | 0.0 | 3.3 | 0.0 | 3.4 | 0.0 | 3.5 | 0.0 |
| 20 | 204 | 3.1 | 0.0 | 3.1 | 0.0 | 3.0 | 0.0 | 3.0 | 0.0 | 3.1 | 0.0 |
| 21 | 214 | 3.0 | 0.0 | 2.9 | 0.0 | 3.0 | 0.0 | 2.7 | 0.0 | 2.7 | 0.0 |
| 22 | 224 | 2.7 | 0.0 | 2.5 | 0.0 | 2.5 | 0.0 | 2.4 | 0.0 | 2.4 | 0.0 |
| 23 | 235 | 2.4 | 0.0 | 2.2 | 0.0 | 2.2 | 0.0 | 2.1 | 0.0 | 2.2 | 0.0 |
| 24 | 245 | 2.2 | 0.0 | 2.1 | 0.0 | 2.2 | 0.0 | 1.9 | 0.0 | 1.9 | 0.0 |
| 25 | 255 | 2.1 | 0.0 | 2.0 | 0.0 | 2.0 | 0.0 | 1.6 | 0.0 | 1.6 | 0.0 |

*brix uncorrected for acid

### Experimental Conclusion

### Simulated Juice

The objective of the first trial was to investigate the possibility of separating a simulated fruit juice aqueous solution containing blue color (non-reactive with the resin), purified fructose, and distilled water (ion-free) into an aqueous blue peak and an aqueous fructose peak with a Dowex® Monosphere® 99CA/320 Separation Resin column. The feed sample was a solution of two pure and contaminate-free carbohydrates. Both peaks were purified, contaminate-free, and absent of free ions. By optimizing the sample size, flow rate, column diameter, and column height, it was possible to separate the simulated fruit juice into a blue dye solution peak and a sugar (fructose) peak.

### Fruit Juices

The objective of trials 2-5 was to investigate the possibility of separating a variety of fruit juice that have different concentrations and composition of unique compounds (contaminates) that could interfere with the chromatography of a sample into a fruit JCP and sugar peak with a Dowex® Monosphere® 99CA/320 Separation Resin column. The process was able to separate each of the juice samples into a Fruit JCP peak and a sugar peak. Fruit juices have different sugar compositions. In addition, the characteristic and properties of each resin and the proper processing parameters are different and, thus, need to be investigated.

The processes discussed herein were able to separate solutions and juices with different sugar compositions, including a simulated juice containing only fructose, concord grape juice containing primarily glucose and fructose, and apple and orange juices containing glucose, fructose, and glucose.

Fruit juices contain a wide array of chemically unique compounds and different sugar compositions. Some compounds are known to bind very strongly with calcium (e.g., pectin); while with other compounds, the binding constant with calcium is unknown (e.g., compounds with a hydroxyl group —OH). Some compounds may have very large binding constants, while others may have a medium, low, or no interaction with calcium. The calcium forms a weak interaction with the hydroxyl group (—OH) on the fructose, sucrose, and/or glucose molecules. The resin may also interact with the hydroxyl groups on other endogenous compounds in the fruit juice. Since the resin complex contains calcium, the endogenous compounds could bind to the calcium, thereby making it unavailable for chromatography. The endogenous compounds could also have a medium or weak interaction which would interfere with the separation or be inert with the calcium-resin complex. Pre-trial, it was unknown and could not be predicted (no reasonable expectation) how the various compounds would affect the chromatographic separation of the different fruit juices.

Fruit Juices contain significant qualities of free ions. The free ions interfere with the chromatographic of the sample by disassociating the calcium from the calcium-resin complex. As the fruit juice stream continues to pass through the column, the resin will become less efficient and will not be able to chromatographically separate the fruit juice. The higher the ion concentration in the fruit juice sample, the more rapid the resin will become unable to separate the sample. The damage to the resin is determined by a combination of time (duration) and ion concentration.

### Apple Juice

The objective of the second trial was to investigate the possibility of separating an apple juice concentrate sample into an apple JCP peak and a sugar peak with a Dowex® Monosphere® 99CA/320 Separation Resin column. The apple juice sample contained free ions, pulp, pectin, fructose, glucose, sucrose, acids, color, apple flavor compounds, and other endogenous compounds (contaminates). The apple juice sample was separated into two peaks. The apple JCP peak contained free ions, apple (light brown) color, apple flavor, apple aroma, pectin, acids, and other endogenous contaminates. The sugar peak contained a mixture of three sugars (fructose, glucose, and sucrose) and minimal concentrations of pulp, pectin, light brown color, apple flavor, aroma, acids, and other endogenous compounds.

By optimizing the sample size, flow rate, column height, and pH, it was possible to separate the apple juice sample into an apple JCP peak and a sugar (fructose, glucose, and sucrose) peak. The apple JCP peak eluted about 6 mls later than the blue color peak in the simulated juice (blue color and fructose solution) of the first trial. The results show that the contaminates (e.g., free ions, pectin, fructose, glucose, sucrose, acids, flavor compounds, aroma compounds, and other endogenous compounds) interfered with the chromatographic separation of the apple juice sample. The elution and shape of the sugar peak was similar in the simulated juice and apple juice trials.

### Concord Grape Juice

The objective of the third trial was to investigate the possibility of separating a concord grape juice sample into a concord grape JCP peak and sugar peak with a Dowex® Monosphere® 99CA/320 Separation Resin column. The concord grape juice sample contained free ions, pulp, pectin, fructose, glucose, pigments, acids, grape flavor compounds and grape aroma compounds, and other endogenous compounds (contaminates). Concord grape juice contains fructose, glucose and may contain trace level of sucrose. The concord grape juice sample was separated into two peaks. The sugar peak contained a mixture of two sugars (fructose and glucose) and minimal concentrations of pulp, pectin, pigments, grape flavor compounds and grape aroma compounds, and other endogenous compounds.

By adjusting the pH and adding free ions (e.g., calcium) to bind to the active sites on the pigment molecules, it was possible to reduce the amount of pigment from being removed from the concord grape juice sample and being absorbed by the resin.

The concord grape JCP peak eluted about 8 mls later than the blue color peak in the simulated juice (blue color and fructose solution) trial. The results show that the contaminates (e.g., free ions, pectin, fructose, glucose, acids, flavor compounds, aroma compounds, and other endogenous compounds) interfered with the chromatographic separation of the concord grape juice sample.

### Orange Juice

The objective of the fourth trial was to investigate the possibility of separating a clarified orange juice sample into an orange JCP peak and sugar peak with a Dowex® Monosphere® 99CA/320 Separation Resin column. Most of the pulp and some of the pectin was removed from the sample. In addition, some of the orange oils were not returned to the orange juice concentrate. The clarified orange juice had most of the pulp removed, and the sample containing free ions, pulp, pectin, orange oils, fructose, glucose, sucrose, orange flavors compounds, orange aroma, acids, and other endogenous compounds (contaminates) was separated into an orange JCP peak and a mixed sugar peak. The “orange JCP” fractions contained free ions, orange color, orange flavor, pectin, orange aroma, acids, and other endogenous compounds (contaminates). The sugar peak contained a mixture of three sugars (fructose, glucose, and sucrose) and minimal concentrations of pulp, pectin, orange color, orange flavor, aroma, acids, and other endogenous compounds.

By optimizing the sample size, flow rate, column height, and pH, it was possible to separate the orange JCP peak from the sugar peak (mixed sugars, fructose, glucose, and sucrose).

The orange juice sample contained more pulp, pectin, orange oils, and other contaminates than the apple juice sample. The orange juice sample was also significantly thicker and more viscous than the apple juice sample. The composition of the orange juice affected the chromatographic separation of the sample and delayed the elution of the orange JCP fraction relative to the simulated juice, apple juice, and concord grape juice samples.

Orange Juice with Chelator

The objective of the fifth trial was to investigate the possibility of separating an orange juice with chelator (e.g., EDTA) sample into an orange with EDTA JCP peak and a sugar peak. The orange juice with EDTA sample contained chelated ions, pulp, pectin, orange oils, fructose, glucose, sucrose, orange flavor compounds, orange aroma, acids, and other endogenous contaminates. The sample was separated with a Dowex® Monosphere® 99CA/320 Separation Resin column into two peaks. The “orange with EDTA JCP” peak contained orange color, orange flavor, pectin, acids, chelated ions, and aroma. The sugar peak contained a mixture of three sugars (fructose, glucose, and sucrose) and minimal concentrations of orange color, orange flavor, aroma, acids, and other endogenous compounds.

By using the optimizing parameters from the clarified orange juice trial, it was possible to separate the orange with EDTA JCP peak from the sugar peak (mixed sugars including fructose, glucose, and sucrose).

It was advantageous to chelate the free ions in the fruit juice sample before introducing the sample into the column, since free ions disassociate the calcium from the calcium-resin complex, which adversely affects the chromatographic separation of the sample. Chelating the free ions protects the calcium-resin complex by reducing the free ions' ability to disassociate the calcium from the calcium-resin complex. Resin beads that lack the calcium ions will be incapable of separating sugars from juice samples.

Since the resin complex has a selective attraction to sugars (e.g., fructose, glucose, and sucrose) in the fruit juice samples, the resulting fruit JCP can be used to produce a reduced-calorie beverage. The beverage would not meet the standard identify for a “fruit juice” but would meet the stand of identity for a “fruit juice beverage.”

While the processes and products herein have been described with reference to various embodiments, those ordinarily skilled in the art will understand that various changes may be made and equivalents may be substituted for elements thereof without departing from the scope and essence of the disclosure. In addition, many modifications may be made to adapt a particular situation or material to the teachings of the disclosure without departing from the scope thereof. Therefore, it is intended that the disclosure not be limited to the particular embodiments disclosed, but that the disclosure will include all embodiments falling within the scope of the appended claims. All citations referred herein are expressly incorporated herein by reference.

1. A method of producing a reduced-calorie fruit juice beverage, comprising:
passing a feed stream of a fruit juice containing endogenous compounds through a bed of resin, the endogenous compounds including sugars and non-sugar juice components, the non-sugar juice components including native free ions and pectin, the resin having an affinity for the sugars;
chromatographically separating the fruit juice into concentrated bands of the non-sugar juice components and the sugars that move through the bed of resin, the concentrated band of the sugars moving at a slower speed through the bed of resin than the concentrated band of the non-sugar juice components due to a weak attraction between the resin and the sugars;
withdrawing the concentrated band of the sugars as a sugar stream from a first extraction point in the bed of resin, the sugar stream including at least fructose and glucose, the sugar stream including at least 45% of the sugars in the feed stream and no more than 35% of the non-sugar juice components in the feed stream; and
withdrawing the concentrated band of the non-sugar juice components as a non-sugar juice components stream from a second extraction point in the bed of resin, the second extraction point being downstream from the first extraction point, the non-sugar juice components stream including a higher concentration of non-sugar juice components than the feed stream or the sugar stream, the non-sugar juice components stream containing at least 65% of the non-sugar juice components in the feed stream and no more than 55% of the sugars in the feed stream.

2. The method of claim 1, wherein the non-sugar juice components stream includes a higher concentration of endogenous flavor compounds, endogenous aroma compounds, endogenous acids, endogenous minerals, and endogenous vitamins than the feed stream or the sugar stream.

3. The method of claim 1, wherein the method is implemented as a simulated moving bed.

4. The method of claim 1, wherein the bed of resin is disposed in one or more columns.

5. The method of claim 1, wherein the sugar stream includes a higher concentration of the fructose, glucose, and sucrose or a higher concentration of fructose and glucose than the feed stream or the non-sugar juice components product stream according to a dry weight basis.

6. The method of claim 1, wherein the non-sugar juice components fraction elutes from the bed of resin before the sugar stream.

7. The method of claim 1, wherein the first extraction point is axially positioned such that a peak of the concentrated band of sugar is withdrawn from the bed of resin with the sugar stream.

8. The method of claim 1, wherein the second extraction point is axially positioned such that a peak of the concentrated band of non-sugar juice components is withdrawn from the bed of resin with the non-sugar juice components stream.

9. The method of claim 1, further comprising:
pretreating the feed stream prior to passing the feed stream through the bed of resin, the pretreating including one or more of reducing or increasing a level of a component in the feed stream, diluting the feed stream, or concentrating the feed stream.

10. The method of claim 1, wherein the fruit juice is not subjected to a deionization process prior to passing through the bed of resin.

11. The method of claim 1, wherein the fruit juice is one or more of orange juice, tangerine juice, grapefruit juice, grape juice, grape wine juice, cranberry juice, apple juice, pineapple juice, blueberry juice.

12. The method of claim 11, wherein the orange juice contains less than 15 weight % (wt/wt) pulp.

13. The method of claim 11, wherein the orange juice contains less than 5 weight % (wt/wt) pulp.

14. The method of claim 1, further comprising:
adding a chelator to the fruit juice feed stream to bind with the native free ions so as to protect against a displacement of metal ions in the resin when the fruit juice feed stream passes through the bed.

15. The method of claim 14, wherein the chelator forms a ligand bond with the native free ions.

16. The method of claim 14, wherein the chelator is added to the fruit juice at a concentration ranging from 0.0001 to 20%.

17. The method of claim 14, wherein the chelator is added to the fruit juice at a concentration ranging from 0.0001 to 2%.

18. The method of claim 14, wherein the chelator is in a form of an acid or a salt.

19. The method of claim 14, wherein the chelator is at least one of ethylenediaminetetraacetic acid (EDTA) and ascorbic acid.

20. The method of claim 1, further comprising:
adding ions to the feed stream to bind with active sites of the endogenous compounds of the fruit juice so as to reduce an interaction with the resin.

21. The method of claim 1, further comprising:
concentrating the non-sugar juice components stream.

22. The method of claim 1, further comprising:
adding a sweetener to the non-sugar juice components stream to produce the reduced-calorie fruit juice beverage.

23. The method of claim 22, wherein the sweetener is at least one of a natural high-intensity sweetener or an artificial high-intensity sweetener.

24. The method of claim 23, wherein the natural high-intensity sweetener is stevia.

25. The method of claim 23, wherein the artificial high-intensity sweetener is at least one of sucralose, aspartame, acesulfame potassium, alitame, cyclamates, and saccharine.

26. The method of claim 1, wherein the resin is an ionic exchange resin that includes metal ions that form the weak attraction with the sugars in the fruit juice.

27. The method of claim 26, wherein the resin is a cationic exchange resin.

28. The method of claim 26, wherein a ligand bond is formed between the resin and the sugars.

29. The method of claim 26, wherein the resin is in salt form.

30. The method of claim 26, wherein the metal ions include at least one of alkali metal ions and alkaline earth metal ions.

31. The method of claim 30, wherein the alkaline earth metal ions are calcium ions.

32. The method of claim 1, wherein the fruit juice is separated into the concentrated bands of the non-sugar juice components and the sugars via exchange chromatography.

33. The method of claim 1, further comprising:
redirecting a remainder of the feed stream from a bottom of the bed to a top of the bed to form a recycle stream, the remainder being a portion of the feed stream that is not part of the sugar stream or the non-sugar juice components stream.
